(19) United States
(12) Patent Application Publication
(10) Pub. No.: US 2021/0359423 A1
(43) Pub. Date: Nov. 18, 2021

(54) ANTENNA MODULE

(71) Applicant: PEGATRON CORPORATION, Taipei City (TW)

(72) Inventors: Chin-Ting Huang, Taipei City (TW); Hsi-Kai Hung, Taipei City (TW); Sony Chayadi, Taipei City (TW); Chun-Kai Wang, Taipei City (TW)

(73) Assignee: PEGATRON CORPORATION, TAIPEI CITY (TW)

(21) Appl. No.: 17/217,596

(22) Filed: Mar. 30, 2021

(30) Foreign Application Priority Data
May 13, 2020 (TW) 109205830

(51) Int. Cl. H01Q 21/06; H01Q 1/52; H01Q 21/00; H01Q 9/04

(52) U.S. Cl. CPC H01Q 21/065; H01Q 9/0407; H01Q 21/0025; H01Q 1/523

(57) ABSTRACT

An antenna module includes three array antenna sets and three ground layers. The three array antenna sets are individually located on different planes, and each of the array antenna sets includes multiple patch antennas. The three ground layers are individually disposed near the three array antenna sets and are apart from the corresponding three array antenna sets.

### CROSS-REFERENCE TO RELATED APPLICATION

This application claims the priority benefit of Taiwan application serial no. 109205830, filed on May 13, 2020. The entirety of the above-mentioned patent application is hereby incorporated by reference herein and made a part of this specification.

### BACKGROUND

### Technology Field

The disclosure relates to an antenna module, and particularly, to an antenna module with array antenna sets.

### Description of Related Art

The design of a conventional millimeter wave array antenna is to dispose multiple rectangular microstrip patch antennas on a non-conductive plate structure to form an array antenna. In operation, currents in different phases are fed into the rectangular microstrip patch antennas, so that the radiation pattern produces a beamforming effect. The beamforming bandwidth of the radiation pattern determines the energy range radiated by the array antenna. At present, the beamforming bandwidth of the conventional millimeter wave array antenna is only 60 degrees, which is difficult to meet current needs.

### SUMMARY

The disclosure provides an antenna module capable of producing a larger beamforming bandwidth.

An antenna module in the disclosure includes three array antenna sets and three ground layers. The three array antenna sets are individually located on different planes, and each of the array antenna sets includes multiple patch antennas. The three ground layers are individually disposed near the three different array antenna sets and are apart from the three array antenna sets.

In an embodiment of the disclosure, the antenna module further includes a substrate assembly including three parts individually located on different planes, and each of the three parts includes a first surface and a second surface opposite to the first surface. The three array antenna sets are individually disposed on the three different first surfaces, and the three ground layers are individually disposed on the three different second surfaces.

In an embodiment of the disclosure, the three parts are three plate structures or the three parts form an arc structure.

In an embodiment of the disclosure, projections of the three array antenna sets onto the three second surfaces are individually located within the areas of the three ground layers.

In an embodiment of the disclosure, the three ground layers are distributed on the entire three second surfaces.

In an embodiment of the disclosure, the antenna module excites at a frequency band and the diagonal length of each of the patch antennas is 0.5 times the wavelength of the frequency band.

In an embodiment of the disclosure, the three array antenna sets are disposed in sequence, one pair of two adjacent array antenna sets among the three array antenna sets forms a first included angle, and other pair of two adjacent array antenna sets among the three array antenna sets forms a second included angle. The first included angle and the second included angle range from 90 degrees to 150 degrees.

In an embodiment of the disclosure, the first included angle is equal to the second included angle.

In an embodiment of the disclosure, each of the patch antennas includes a feeding end at the center. In an embodiment of the disclosure, two adjacent patch antennas in each of the array antenna sets have two closest edges, and the two closest edges are parallel to each other.

Based on the above, the antenna module in the disclosure has three array antenna sets individually located on different planes and three ground layers individually disposed near and apart from the three array antenna sets. With this design, the radiation patterns of the antenna module are capable of having a larger beamforming bandwidth and a larger coverage of communication transmission energy.

### BRIEF DESCRIPTION OF THE DRAWINGS

FIG. 1 is a schematic view of an antenna module according to an embodiment of the disclosure.

FIG. 2A to FIG. 2G are two-dimensional beam radiation patterns when currents in different phases are fed into the antenna module of FIG. 1.

FIG. 3 is a schematic view of an antenna module according to another embodiment of the disclosure.

### DESCRIPTION OF THE EMBODIMENTS

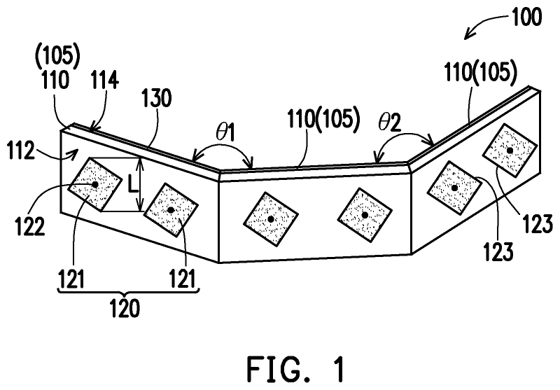

FIG. 1 is a schematic view of an antenna module according to an embodiment of the disclosure. Referring to FIG. 1, an antenna module 100 in the embodiment may be a millimeter wave array antenna with a wide bandwidth, which may be applied to 5G mobile communications and has an operating frequency of 37 GHz. However, the applicable frequency band of the antenna module 100 is not limited thereto.

In the embodiment, the antenna module 100 includes three array antenna sets 120, a substrate assembly 105, and three ground layers 130. Note that the number of the array antenna sets 120 and the number of the ground layers 130 are not limited to three. In other embodiments, the number of the array antenna sets 120 and the number of the ground layers 130 may be more than three. For example, the number of the array antenna sets 120 may be nine (but the disclosure is not limited thereto) and the array antenna sets 120 are in a circle.

In the embodiment, the three array antenna sets 120 are individually located on different planes. The three ground layers 130 are disposed near the three respective array antenna sets 120 and are apart from the three respective array antenna sets 120. More specifically, the substrate assembly 105 is a dielectric layer. The substrate assembly 105 includes three parts (e.g., three plate structures 110) that are located on respective planes, and each of the three parts (three plate structures 110) include a first surface 112 and a second surface 114 opposite the first surface 112. The three array antenna sets 120 are disposed on the three respective first surfaces 112, and the three ground layers 130 are disposed on the three respective second surfaces 114.

In addition, in other embodiments, the substrate assembly 105 may not be necessary to be disposed between the array antenna set 120 and the ground layer 130, as long as an air layer (not shown) exists between the array antenna set 120 and the ground layer 130 for separation.

In the embodiment, the three ground layers 130 are distributed on the entire three second surfaces 114 so that the projections of the three array antenna sets 120 onto the three second surfaces 114 are individually located within the areas of the three ground layers 130. In other embodiments, the three ground layers 130 may also be partially distributed on the areas of the three second surfaces 114 as long as the projection of each array antenna set 120 onto one of the three second surfaces 114 is located within the area of one of the three ground layers 130.

In the embodiment, each of the array antenna sets 120 includes multiple patch antennas 121. For example, each of the array antenna sets 120 may include two patch antennas 121. However, in other embodiments, the number of the patch antennas 121 may be more than two. Each of the patch antennas 121 includes a feeding end 122 at the center, and the position of the feeding end 122 is adjustable to change the feed impedance of each of the patch antennas 121.

The antenna module 100 in the embodiment excites at a frequency band, such as 37 GHz, but the disclosure is not limited thereto. A diagonal length L of each of the patch antennas 121 is 0.5 times the wavelength of the frequency band. In the embodiment, for example, the shape of the patch antenna 121 is square. However, in other embodiments, the shape of the patch antenna 121 may also be rectangular. The shape of the patch antenna 121 is not limited thereto as long as the diagonal length L is 0.5 times the wavelength of the frequency band.

In addition, in the embodiment, the shapes and the sizes of the patch antennas 121 are the same. In other embodiments, the shape and the size of the patch antenna 121 in one array antenna set 120 may also be different from the shape and the size of the patch antenna 121 in another array antenna set 120, and they are not limited by the drawing.

In addition, two adjacent patch antennas 121 in each array antenna set 120 have two closest edges 123, and the two closest edges 123 are parallel to each other. In the embodiment, the patch antennas 121 of each array antenna sets 120 are adhered on the first surface 112 of the plate structure 110 in the same angle.

Note that although the patch antennas 121 of the three array antenna sets 120 are all adhered on the substrate assembly 105 in the same angle in this embodiment, the patch antennas 121 of one array antenna set 120 and the patch antennas 121 of another array antenna set 120 may be adhered on the substrate assembly 105 in different angles in other embodiments.

As shown in FIG. 1, one pair of two adjacent array antenna sets among the three array antenna sets forms a first included angle θ1, and other pair of two adjacent array antenna sets forms a second included angle θ2. The first included angle θ1 and the second included angle range from 90 degrees to 150 degrees. In the embodiment, the first included angle θ1 is equal to the second included angle θ2, which provides a symmetrical radiation pattern. The first included angle θ1 and the second included angle θ2, for example, may be 120 degrees. In other embodiments, the first included angle θ1 may be different from the second included angle θ2, depending on the requirements of special radiation pattern types.

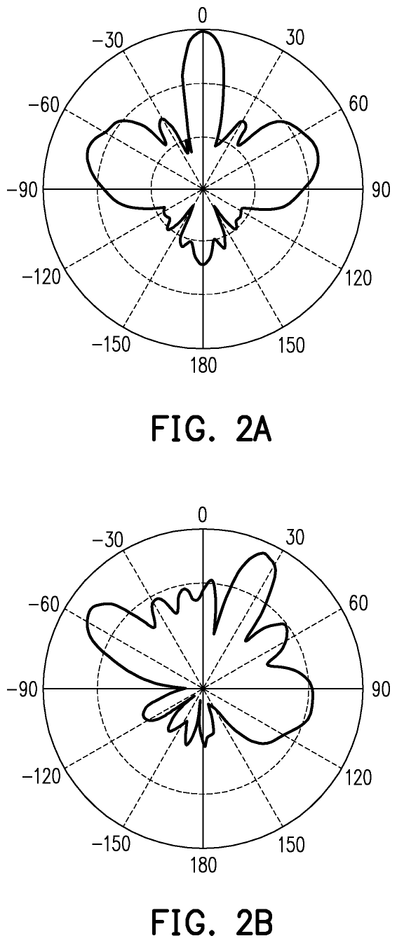

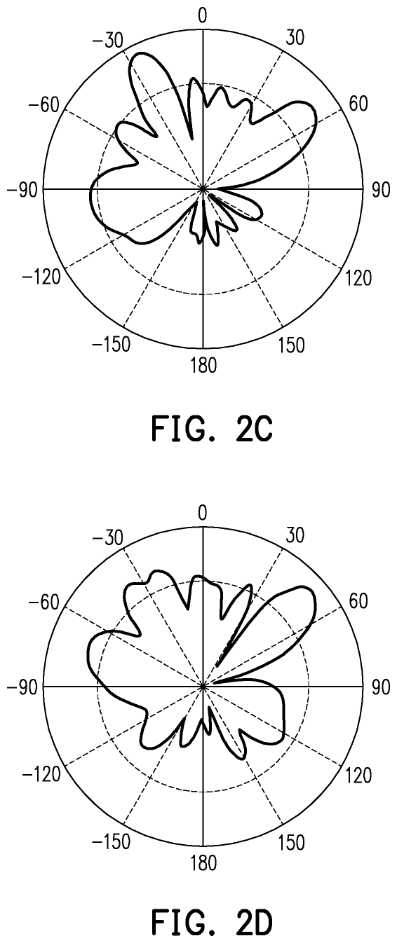

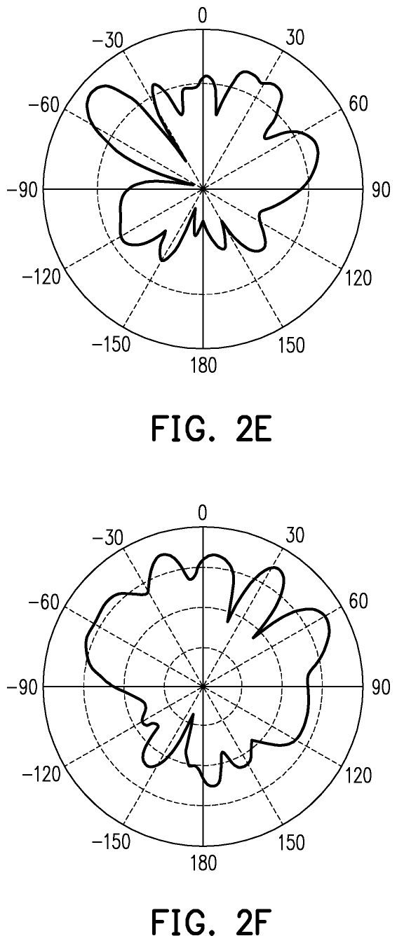

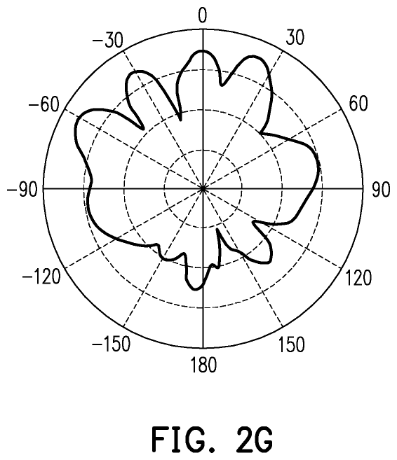

FIG. 2A to FIG. 2G are two-dimensional beam radiation patterns when currents in different phases are fed into the antenna module of FIG. 1. In the embodiment, the antenna module 100 has six feeding ends 122 in total. FIG. 2A to FIG. 2G illustrate the two-dimensional beam radiation patterns, using CST software to simulate currents in different phases fed into the six feeding ends 122, from left to right, in the antenna module 100 of FIG. 1.

Referring to FIG. 2A first, the main beam is located at 0 degrees, and the gain is 9.5 dBi when the six feeding ends 122 from left to right in the antenna module 100 of FIG. 1 are fed with the currents in the phases of 0, 90, 0, 0, 90, and 0.

Referring to FIG. 2B, the main beam is located at 25 degrees, and the gain is 8.2 dBi when the six feeding ends 122 from left to right in the antenna module 100 of FIG. 1 are fed with the currents in the phases of 0, 90, 270, 90, 90, and 180.

Referring to FIG. 2C, the main beam is located at −25 degrees, and the gain is 8.2 dBi when the six feeding ends 122 from left to right in the antenna module 100 of FIG. 1 are fed with the currents in the phases of 180, 90, 90, 270, 90, and 0.

Referring to FIG. 2D, the main beam is located at 50 degrees, and the gain is 7.4 dBi when the six feeding ends 122 from left to right in the antenna module 100 of FIG. 1 are fed with the currents in the phases of 0, 90, 90, 270, 90, and 90.

Referring to FIG. 2E, the main beam is located at −50 degrees, and the gain is 7.4 dBi when the six feeding ends 122 from left to right in the antenna module 100 of FIG. 1 are fed with the currents in the phases of 90, 90, 270, 90, 90, and 0.

Referring to FIG. 2F, the main beam is located at 60 degrees; and the gain is 6.3 dBi when the six feeding ends 122 from left to right in the antenna module 100 of FIG. 1 are fed with the currents in the phases of 0, 180, 270, 0, 90, and 90.

Referring to FIG. 2G, the main beam is located at −60 degrees, and the gain is 6.3 dBi when the six feed-in terminals 122 from left to right in the antenna module 100 of FIG. 1 are fed with the currents in the phases of 90, 90, 0, 270, 180, and 0.

From FIG. 2A to FIG. 2G, the maximum beamforming bandwidth of the antenna module 100 in the embodiment ranges from −60 degrees to 60 degrees, and the overall range may reach 120 degrees. Therefore, when the antenna module 100 in the embodiment is applied to 5G mobile communication products, the coverage of the communication transmission energy is twice the size of the traditional design.

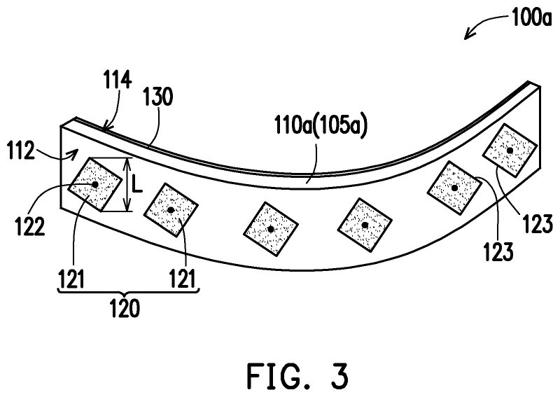

FIG. 3 is a schematic view of an antenna module according to another embodiment of the disclosure. Referring to FIG. 3, in the embodiment, a substrate assembly 105a of an antenna module 100a also has an arc structure 110a, and the three parts of the substrate assembly 105a located on different planes may be located at different parts of the arc structure 110a.

Based on the above, the antenna module in the disclosure has three array antenna sets located on different planes and three ground layers disposed near and apart from the three array antenna sets. With this design, the radiation patterns of the antenna module are capable of having a larger beamforming bandwidth and a larger coverage of communication transmission energy.

What is claimed is:

1. An antenna module, comprising:
three array antenna sets individually located on different planes, wherein each of the three array antenna sets comprises a plurality of patch antennas; and
three ground layers individually disposed near the three different array antenna sets and apart from the three array antenna sets.

2. The antenna module according to claim 1, further comprising:
a substrate assembly comprising three parts individually located on different planes, wherein each of the three parts comprises a first surface and a second surface opposite the first surface, the three array antenna sets are individually disposed on the three different first surfaces, and the three ground layers are individually disposed on the three different second surfaces.

3. The antenna module according to claim 2, wherein the three parts are three plate structures or the three parts form an arc structure.

4. The antenna module according to claim 2, wherein projections of the three array antenna sets onto the three second surfaces are individually located within the areas of the three ground layers.

5. The antenna module according to claim 2, wherein the three ground layers are distributed on the entire three second surfaces.

6. The antenna module according to claim 1, wherein the antenna module excites at a frequency band and a diagonal length of each of the plurality of the patch antennas is 0.5 times a wavelength of the frequency band.

7. The antenna module according to claim 1, wherein one pair of two adjacent array antenna sets among the three array antenna sets forms a first included angle, and other pair of two adjacent array antenna sets among the three array antenna sets forms a second included angle, and the first included angle and the second included angle range from 90 degrees to 150 degrees.

8. The antenna module according to claim 7, wherein the first included angle is equal to the second included angle.

9. The antenna module according to claim 1, wherein each of the plurality of the patch antennas comprises a feeding end at the center.

10. The antenna module according to claim 1, wherein two adjacent patch antennas in each of the three array antenna sets comprise two closest edges and the two closest edges are parallel to each other.
